(19) United States
(12) Patent Application Publication
(10) Pub. No.: US 2011/0283543 A1
(43) Pub. Date: Nov. 24, 2011

(54) Utility Knife With Step Extending Blade

(76) Inventor: Yuewei Wu, Ninghai (CN)

(21) Appl. No.: 12/784,954

(22) Filed: May 21, 2010

(51) Int. Cl. B26B 1/08; B26B 5/00

(52) U.S. Cl. 30/162; 30/337

(57) ABSTRACT

A utility knife with step extending blade has a housing, a blade seat slidably received in the housing, a blade fixed to the blade seat, an actuator fixed to the blade seat and reciprocally slidable along the housing, a blade seat return spring linking the blade seat and the housing, a step extending control unit, and a blade change means. An extending length of the blade of the utility knife is step regulatable according to different thickness of workpiece, thus decreasing the possibility of break of the blade.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a utility knife with step extending blade, and more particularly, to a utility knife an extending length of the blade thereof is step regulatable according to different thickness of workpiece.

2. Description of Related Art

Utility knife is a commonly used hand tool for cutting, e.g., wood, paper, leather, plastic panel, cord, and cardboard. Shown in FIG. 9 is a conventional utility knife 9 a blade 90 thereof is at a status of fully extending for use. However, the blade 90 is only able to stop at the fully extended or a retracted back positions and not able to stay at anywhere therebetween. When used to cut a relatively thin workpiece, the blade 90 may extend too long to withstand a side bending torque caused by possible instability of a hand holding the utility knife 9. When the extending blade 90 is long, a very tiny side movement of the hand may break the blade 90.

### BRIEF SUMMARY OF THE INVENTION

The main object of the invention is to provide a utility knife with step extending blade an extending length of the blade thereof being step regulatable according to different thickness of workpiece, thus decreasing the possibility of break of the blade.

In order to accomplish above object, the invention provides a utility knife with step extending blade having:
a housing having an indication window, a wheel window, and a directing slope;
a blade seat slidably received in the housing and having a seat notch;
a blade fixed to the blade seat and having at least one blade notch;
an actuator fixed to the blade seat and reciprocally slidable along the housing;
a blade seat return spring having one end fixed to the blade seat and the other end fixed to an inner surface of the housing;
a step extending control unit contained in the housing, and,
a blade change means having a stop device and a fixing device.

The step extending control unit has a linking shaft having one end fixed to the blade seat and a free end, an adjust wheel slidably covering on the linking shaft and partially exposing out from the wheel window, a step sleeve concentrically fixed with respect to the adjust wheel and covering on the linking shaft, an indication ring having status index symbols and concentrically fixed with respect to the adjust wheel, and a bearing ring slidably covering on the step sleeve and securely fixed within the housing. A protrusion is formed on the free end of the linking shaft. The step sleeve having a plurality of steps and an elastic tongue formed therein. The, tongue has an upturned tip. The bearing ring has the plurality of recesses equal to the steps formed in a peripheral of an inner opening thereof each of which is able to receive the upturned tip. The stop device has an outer button and an inner part detachably coupling to the outer button. The fixing device is rotatably fixed to the blade seat and has a side protruding pressing finger, a side protruding bias slope, and a bias spring provided between the fixing device and the blade seat.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1a is a perspective view of the preferred embodiment of the utility knife of the invention.

FIG. 1b is another perspective view thereof in a roughly reverse view angle with respect to FIG. 1a.

FIG. 2 is an exploded perspective view thereof.

FIG. 3a is a perspective partial view showing a blade seat and a step extending control unit thereof.

FIG. 3b is an enlarged perspective partial view showing the step extending control unit.

FIG. 4 is a perspective exploded view showing a status of safety thereof.

FIGS. 5a and 5b are perspective exploded views showing a status of slightly extending thereof.

FIGS. 6a and 6b are perspective exploded views showing a status of medium extending thereof.

FIGS. 7a and 7b are perspective exploded views showing a status of fully extending thereof.

FIG. 8a through 8c are perspective exploded views showing a status of blade change thereof. And,

FIG. 9 is a perspective view of a conventional utility knife.

### DETAILED DESCRIPTION OF THE INVENTION

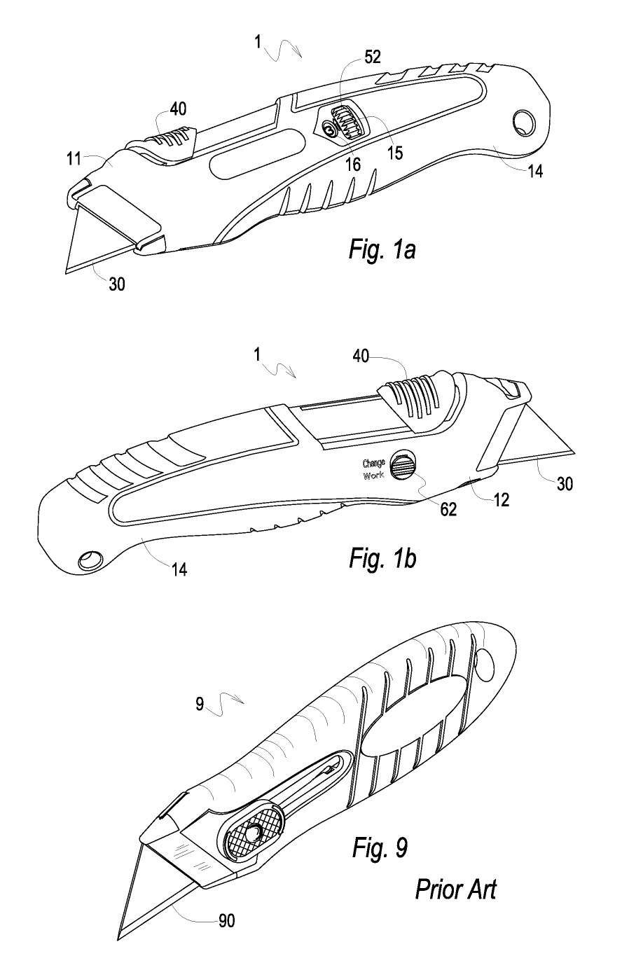

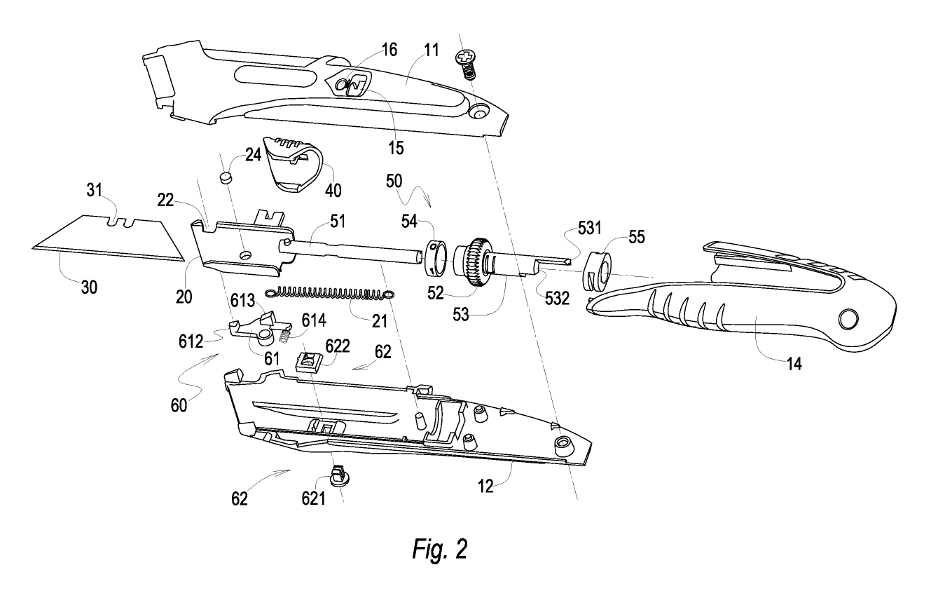

With reference to FIGS. 1a, 1b, and 2, a utility knife 1 with step extending blade of the preferred embodiment of the invention is shown. The utility knife 1 has a housing 10 made up of a first side cover 11 and a second side cover 12 detachably coupling together, a blade seat 20 slidably received in the housing 10, a blade 30 fixed to the blade seat 20, an actuator 40 fixed to the blade seat 20 and reciprocally slidable along the housing 10 for controlling the blade seat 20 to move forward, a blade seat return spring 21 one end thereof is fixed to the blade seat 20 and the other end thereof is fixed to an inner surface of the housing 10, a step extending control unit 50 contained in the housing 10, and a blade change means 60. The housing 10 acts as both a container for the blade seat 20 and a handle. A wheel window 15 and an indication window 16 are defined in the housing 10.

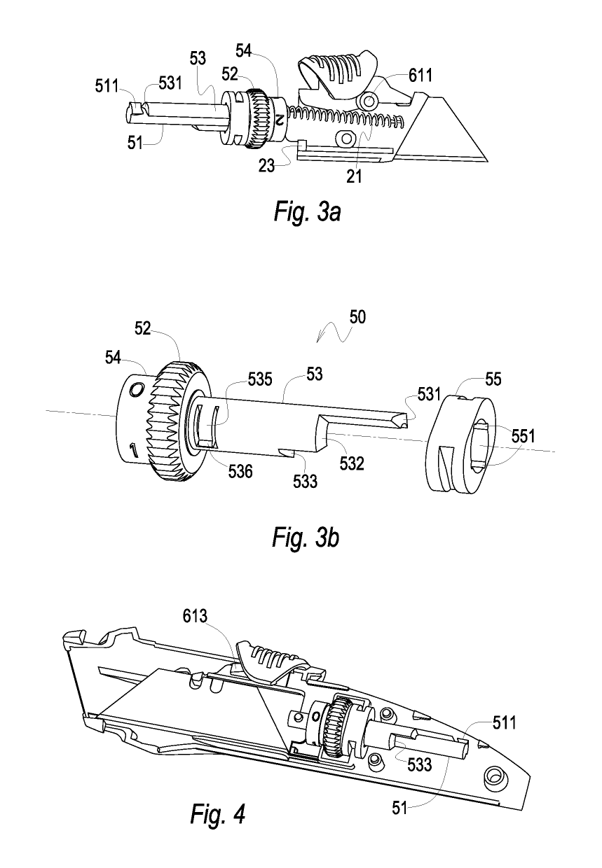

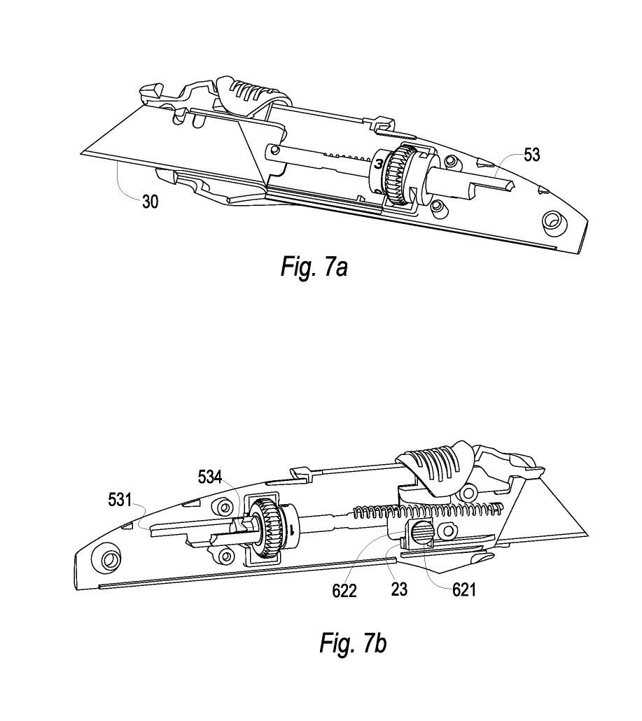

Together with reference to FIGS. 3a and 3b, the step extending control unit 50 has a linking shaft 51 fixed to the blade seat 20, an adjust wheel 52 slidably covering on the linking shaft 51, a step sleeve 53 concentrically fixed with respect to the adjust wheel 52 and covering on the linking shaft 51, an indication ring 54 having status index symbols and concentrically fixed with respect to the adjust wheel 52, and a bearing ring 55 slidably covering on the step sleeve 53 and securely fixed within the housing 10. A protrusion 511 is formed on a free end of the linking shaft 51. The step sleeve 53 has a plurality of steps formed therein. In this embodiment, four steps, including an utmost step 531, a second step 532, a third step 533, and a fourth step 534 (particularly shown in FIG. 7b), are formed in the step sleeve 53. The step sleeve 53 has an elastic tongue 535 formed therein and the tongue 535 has an upturned tip 536 higher than a peripheral surface of the step sleeve 53. The plurality, which is equal to that of steps, of recesses 551 are formed in a peripheral of an inner opening of the bearing ring 55. Each recess 551 is able to receive the upturned tip 536. The adjust wheel 52 partially exposes out from the wheel window 15 so that a user is able to rotate the adjust wheel 52 with his finger from exterior of the housing 10:

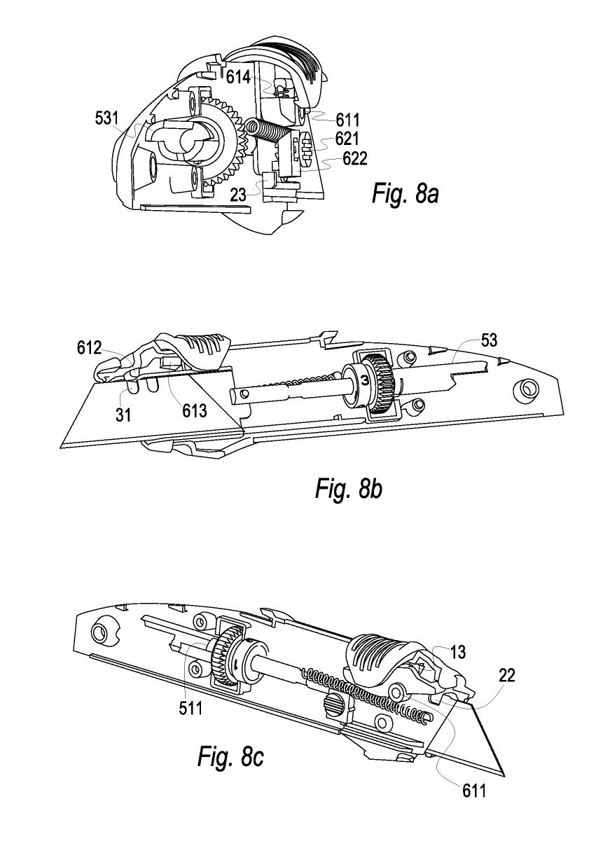

With reference to FIGS. 2 and 8a, the blade change means 60 has a fixing device 61 and stop device 62. The stop device 62 is contained in a channel defined in the housing 10 and reciprocally movable with respect thereto between an upper most “Change” position and a lower most “Work” position as shown in FIG. 1b. The stop device 62 has an outer button 621 for facilitating pushing with a thumb of a user and an inner part 622 detachably coupling to the outer button 621. The fixing device 61 is rotatably fixed to the blade seat 20 by a pivot 611 and has a side protruding pressing finger 612 and a side protruding bias slope 613. The pressing finger 612 is normally received in a seat notch 22 defined in the blade seat 20 and maintained there by a bias spring 614 provided between the fixing device 61 and the blade seat 20.

Shown in FIG. 4 is a spare status of the utility knife 1 of the invention. The blade seat 20 is pulled by the blade seat return spring 21 to a retracted position and the outer button 621 is moved downward to the Work position. In this status, the user is able to rotate the adjust wheel 52 to a position at which the utmost step 531 of the step sleeve 53 fixed to the adjust wheel 52 becomes in align with the protrusion 511 of the linking shaft 51, as shown in FIGS. 3a and 4. The upturned tip 536 just enters one of the four recesses 551 for positioning of the adjust wheel 52 and a symbol, in this embodiment, a digital “0”, on the indication ring 54 rotating with the adjust wheel 52 is just in align with the indication window 16 in the housing 10, telling the user that the utility knife 1 is in a safety status. At this time, a forward movement of the blade seat 20 and the linking shaft 51 will be stopped by the utmost step 531 blocking the protrusion 511, so that the user will not able to move forward the actuator 40 to extend the blade 30 installed on the blade seat 20.

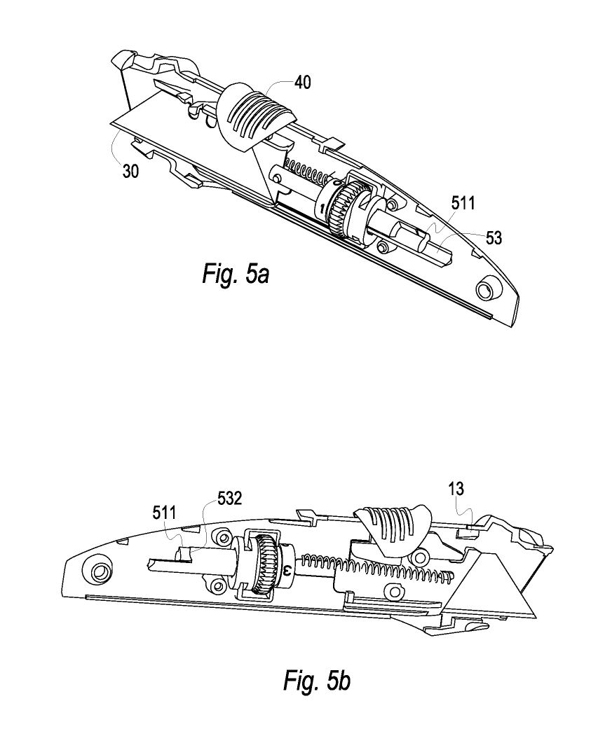

As shown in FIGS. 5a and 5b, if the user rotate the adjust wheel 52 to a position at which the second step 532 of the step sleeve 53 becomes in align with the protrusion 511 of the linking shaft 51, the upturned tip 536 will just enter another neighboring one of the four recesses 551 and another symbol, in this embodiment, a digital “1”; on the indication ring 54 becomes just in align with the indication window 16. At this time, a forward movement of the blade seat 20 and the linking shaft 51 will be stopped by the second step 532 blocking the protrusion 511, so that the user will only be able to move forward the actuator 40 to extend the blade 30 in a distance equal to that between the utmost and the second steps 531 and 532. The utility knife 1 is in a slightly extending status.

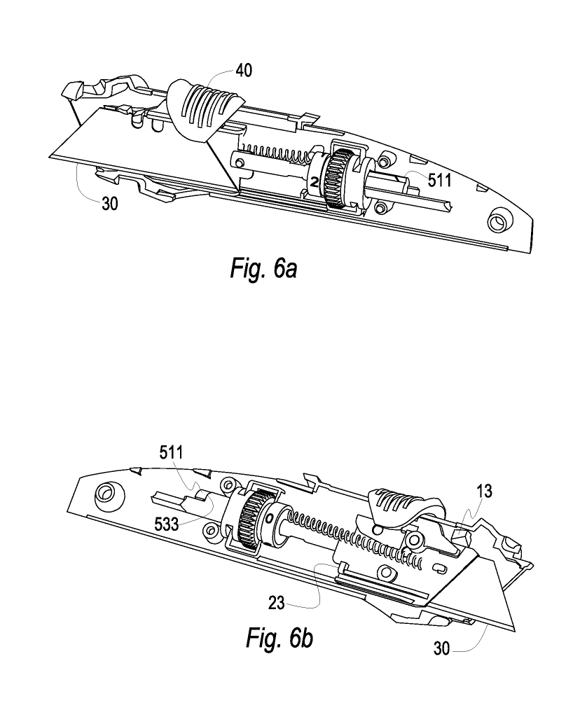

As shown in FIGS. 6a and 6b, if the user rotate the adjust wheel 52 to a position at which the third step 533 of the step sleeve 53 becomes in align with the protrusion 511 of the linking shaft 51, the upturned tip 536 will just enter yet another one of the four recesses 551 and yet another symbol, in this embodiment, a digital “2”, on the indication ring 54 becomes just in align with the indication window 16. At this time, a forward movement of the blade seat 20 and the linking shaft 51 will be stopped by the third step 533 blocking the protrusion 511, so that the user will only be able to move forward the actuator 40 to extend the blade 30 in a distance equal to that between the utmost and the third steps 531 and 532. The utility knife 1 is in a medium extending status.

As shown in FIGS. 7a and 7b, if the user rotate the adjust wheel 52 to a position at which the fourth step 534 of the step sleeve 53 becomes in align with the protrusion 511 of the linking shaft 51, the upturned tip 536 will just enter still yet another one of the four recesses 551 and still yet another symbol, in this embodiment, a digital “3”, on the indication ring 54 becomes just in align with the indication window 16. At this time, a forward movement of the blade seat 20 and the linking shaft 51 will be stopped by a seat protrusion 23 securely formed on the blade seat 20 blocking the inner part 622 of the stop device 62, so that the user will be able to fully move forward the actuator 40 to extend the blade 30, in a distance equal to that between the seat protrusion 23 and the inner part 622. There is still a small distance between the protrusion 511 and the fourth step 534. The utility knife 1 is in a fully extending status.

FIG. 8a through 8c are perspective exploded views showing a status of blade change of the utility knife 1. When the user needs to change a new blade 30, he is able to move the outer button 621 upward to the Change position. The inner part 622 of the stop device 62 will move upward out the way which the seat protrusion 23 goes and the user will be able to move forward the actuator 40 to extend the blade 30 up until the protrusion 511 meets and is stopped by the fourth step 534. Together with reference to FIG. 2, during this process, the bias slope 613 will meet a directing slope 13 securely formed on an inner surface of the housing 10 and be pushed by the directing slope 13 to rotate around the pivot 611 against the bias spring 614. Thus, the pressing finger 612 will leave the seat notch 22 and a blade notch 31. The blade 30 will be able to be pulled out from the utility knife 1 and a new blade 30 will be able to be inserted. After the new blade 30 is inserted, the user is able to release the actuator 40, and the blade seat 20, together with the blade 30 installed thereon, will be retracted back into the housing 10 under a pulling force from the blade seat return spring 21. And when the bias slope 613 leaves the directing slope 13, the fixing device 61 will rotate under a bias pressure of the bias spring 614 until the pressing finger 612 enters the seat notch 22 and the blade notch 31. The new blade 30 is thus able to be securely installed.

Back to FIG. 2, a magnet 24 may be fixedly installed on the blade seat 20 on a surface facing the blade 30. The magnet 24 is able to make the blade 30, which is ferrous, stabler with respect to the blade seat 20. A rubber housing cover 14 also may be provided to improve feeling of grasping of the utility knife 1.

From above description, it could be seen that with the step extending control unit 50, an extending length of the blade 30 of the utility knife 1 becomes step regulatable. According to different thickness of workpiece, a user is able to decide and select a suitable length for cutting, thus decreasing the possibility of break of the blade 30.

From above description, it is seen that the object of the present invention has been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A utility knife with step extending blade comprising:
a housing having an indication window, a wheel window, and a directing slope;
a blade seat slidably received in said housing and having a seat notch;
a blade fixed to said blade seat and having at least one blade notch;
an actuator fixed to said blade seat and reciprocally slidable along said housing;
a blade seat return spring having one end fixed to said blade seat and the other end fixed to an inner surface of said housing;
a step extending control unit contained in said housing, said step extending control unit having a linking shaft having one end fixed to said blade seat and a free end, an adjust wheel slidably covering on said linking shaft and partially exposing out from said wheel window, a step sleeve concentrically fixed with respect to said adjust wheel and covering on said linking shaft, an indication ring having status index symbols and concentrically fixed with respect to said adjust wheel, and a bearing ring slidably covering on said step sleeve and securely fixed within said housing, a protrusion being formed on said free end of said linking shaft, said step sleeve having a plurality of steps and an elastic tongue formed therein, said tongue having an upturned tip, said bearing ring having said plurality of recesses formed in a peripheral of an inner opening thereof each of which is able to receive said upturned tip; and,
a blade change means having a fixing device and a stop device, said stop device having an outer button and an inner part detachably coupling to said outer button, and said fixing device being rotatably fixed to said blade seat and having a side protruding pressing finger, a side protruding bias slope, and a bias spring provided between said fixing device and said blade seat.

2. The utility knife with step extending blade as claimed in claim 1, wherein said housing is made up of a first side cover and a second side cover detachably coupling together.

3. The utility knife with step extending blade as claimed in claim 1, wherein said plurality is 4.

4. The utility knife with step extending blade as claimed in claim 2, wherein said plurality of 4.

5. The utility knife with step extending blade as claimed in claim 1, wherein said utility knife further has a rubber housing cover.

6. The utility knife with step extending blade as claimed in claim 2, wherein said utility knife further has a rubber housing cover.

7. The utility knife with step extending blade as claimed in claim 3, wherein said utility knife further has a rubber housing cover.

8. The utility knife with step extending blade as claimed in claim 4, wherein said utility knife further has a rubber housing cover.

9. The utility knife with step extending blade as claimed in claim 1, wherein a magnet is fixedly installed on said blade seat on a surface facing said blade.

10. The utility knife with step extending blade as claimed in claim 5, wherein a magnet is fixedly installed on said blade seat on a surface facing said blade.

11. The utility knife with step extending blade as claimed in claim 6, wherein a magnet is fixedly installed on said blade seat on a surface facing said blade.

12. The utility knife with step extending blade as claimed in claim 7, wherein a magnet is fixedly installed on said blade seat on a surface facing said blade.

13. The utility knife with step extending blade as claimed in claim 8, wherein a magnet is fixedly installed on said blade seat on a surface facing said blade.
